(19) United States
(12) Patent Application Publication
(10) Pub. No.: US 2026/0347013 A1
(43) Pub. Date: Nov. 5, 2026

(54) Closed-loop ion propulsion system for spacecraft with near zero-mass change and external electric field-induced ion deceleration

(71) Applicants: Benedict de St. Amatus, Forest Glen (AU); Alexander de St. Amatus, Forest Glen (AU)

(72) Inventors: Benedict de St. Amatus, Forest Glen (AU); Alexander de St. Amatus, Forest Glen (AU)

(21) Appl. No.: 19/193,994

(22) Filed: Apr. 30, 2025

(51) Int. Cl. B64G 1/40; F03H 1/00

(52) U.S. Cl. CPC B64G 1/413; F03H 1/0056

(57) ABSTRACT

A spacecraft propulsion system for interplanetary and interstellar travel operates in vacuum environments and generates thrust without continuous mass expulsion. The system includes a motor comprising an ionisation and propulsion module that ionises neutral atoms into ions and emits them into space toward a target with initial momentum, inducing a reactive force on the spacecraft. As the ions travel forward, they interact with external electric fields, which reduce their momentum before being intercepted by the target. The ions follow a closed-loop charge and mass transfer path that includes forward travel through space and a return pathway that is shielded from external electric fields. Only the momentum change during forward travel contributes to thrust, enabling the spacecraft to maintain mass and charge neutrality during steady-state operation.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates to aerospace engineering, and more particularly to spacecraft propulsion systems for interplanetary and interstellar travel that operate with near zero-mass change using external electric field-induced ion deceleration.

### DESCRIPTION OF RELATED ART

Historically, spacecraft propulsion systems have relied on Newtonian reaction-based mechanisms wherein momentum is transferred through the expulsion of mass. Chemical propulsion systems exemplify this approach, providing high thrust-to-weight ratios. However, these systems are fundamentally constrained by the necessity of carrying finite onboard propellant, thereby limiting mission duration, range, and manoeuvrability.

Electric propulsion systems, such as ion thrusters and Hall effect devices (Goebel and Katz, 2008), represent a significant advancement in specific impulse efficiency. These systems generate thrust by accelerating ionised particles using internal electric fields, magnetic fields, or a combination of both. Nevertheless, their operational viability is still dependent on the consumption of reaction mass.

To address the constraints of the chemical and electric propulsion systems, various alternative propulsion concepts have been proposed that reduce or eliminate reliance on consumable propellant. Among these are the Magnetic Sail (MagSail) (Andrews and Zubrin, 1990), Electric Sail (E-Sail) (Janhunen, 2014), and Induced Magnetosphere Propulsion (IMP) (Vulpetti, 1994). MagSails operate by deploying large superconducting coils that generate magnetic fields to deflect charged particles in the solar wind, thereby producing a reactive force. E-Sails consist of long, positively charged tethers that repel solar wind protons, generating directional thrust. IMP systems create artificial magnetospheres by means of plasma clouds or current-carrying structures, which then interact with ambient magnetic fields to produce propulsion. Photonic propulsion has also been explored as a non-mass-expelling alternative (Michaelis and Forbes, 2006), wherein thrust is produced by the transfer of momentum from emitted or reflected photons.

Speculative models, such as warp drives and reactionless drives (Everett and Roman, 2011), have been theorised but remain without empirical support. These concepts often conflict with fundamental physical laws, such as the conservation of energy and momentum, and are generally regarded as non-viable for practical engineering implementation under current scientific paradigms.

A system disclosed in USPTO application Ser. No. 19/001,439, titled “Near zero-mass change propulsion system for interplanetary and interstellar spacecraft”, introduces a spacecraft's propulsion architecture comprising at least one electron emitter and one electrically conductive target, connected by at least one conductive link (conductor) between the target and the emitter, and mounted on a rigid, non-deformable frame aligned with the spacecraft's trajectory.

During operation, the emitter projects a beam of electrons toward the target across a vacuum. As the electrons transit through space, their momentum is reduced through interaction with external electric and magnetic fields. These electric and magnetic fields may originate from various sources, including solar, interstellar, intergalactic, artificial, or any combination thereof.

The reduction in electron momentum results in a corresponding reaction force on the emitter assembly, thereby generating thrust in the opposite direction, consistent with conservation of momentum.

The emitted electrons are collected at the target, where the charges establish an electric potential relative to the emitter. This potential drives a return current via the conductor, thereby maintaining the spacecraft's electrical neutrality. The conductor, configured as a rigid, non-elastic structure, ensures that the charge returns without introducing net momentum to the spacecraft, as the electrons experience no external force within the conductor.

To counteract charge imbalances during transient operational phases, namely the start-up and shutdown of the electron beam, a Dynamic Charge Neutralisation (DCN) system comprising a plurality of ion thrusters is employed. These thrusters selectively eject positive or negative charges into the vacuum in response to real-time measurements, thereby restoring net neutrality and preventing the build-up of electrostatic potential that could result in unintended Lorentz forces acting on the spacecraft.

The positions of the emitter and target are adjustable and reversible along the rigid frame, allowing the system to switch between acceleration and deceleration modes. Furthermore, the angular orientation of the emitter and target can be varied in response to changes in the direction and intensity of ambient magnetic fields, thus preserving optimal beam alignment and ensuring accurate targeting under dynamic environmental conditions.

Beam divergence due to mutual electron repulsion is mitigated by ensuring that the target area exceeds the cross-sectional spread of the electron beam. The design maintains beam integrity over operational distances, preventing dispersion of electrons into space and ensuring recovery of emitted charge.

A principal limitation of the system disclosed in USPTO application Ser. No. 19/001,439, titled “Near zero-mass change propulsion system for interplanetary and interstellar spacecraft”, arises from the high electric charge-to-mass ratio of the emitted particles, namely electrons. The electron possesses an elementary charge of approximately 1.602×10⁻¹⁹ C and a rest mass of approximately 9.109×10⁻³¹ kg, resulting in a charge-to-mass ratio of approximately 1.76×10¹¹ C/kg. This exceedingly high ratio necessitates the emission of a large number of electrons to generate a measurable net momentum at the moment of emission, thereby resulting in high current levels through the conductor and significant beam divergence resulting from mutual Coulomb repulsion between the electrons.

Emitting particles with a lower electric charge-to-mass ratio, such as protons, which carry the same elementary charge of approximately 1.602×10⁻¹⁹ C but have a significantly greater mass of approximately 1.673×10⁻²⁷ kg, yielding a charge-to-mass ratio of approximately 9.58×10⁻⁷ C/kg, would substantially reduce the number of particles required to achieve the same momentum transfer at the moment of emission. This reduction in particle count would correspondingly lower the electric current in the system and minimise beam divergence due to mutual repulsion, thereby improving efficiency and system stability.

### OBJECT OF THE INVENTION

The object of the present invention is to provide a spacecraft propulsion system that operates on the principle of near zero-mass change, while addressing limitations associated with the use of high charge-to-mass ratio particles, such as electrons. In particular, the invention aims to reduce the required particle flux, mitigate beam divergence resulting from mutual Coulomb repulsion, and lower electric current demands within the propulsion system, thereby extending the potential range and duration of space missions.

### SUMMARY OF THE INVENTION

The present invention discloses a spacecraft propulsion system configured for interplanetary and interstellar travel, operating within vacuum environments and utilising external electric fields to achieve thrust without continuous mass expulsion.

The propulsion system comprises a motor mounted on a rigid, non-deformable structural frame aligned with the spacecraft's trajectory. The motor includes an ionisation and propulsion module that ionises neutral atoms into either positively or negatively charged ions and emits them in a directed stream into space with an initial momentum. The emission of the ions induces a reactive force on the spacecraft in a direction opposite to the propagation of the ions. As the ions travel toward a tapered target, they traverse an interplanetary or interstellar vacuum environment and interact with an external electric field that performs work on the ions, thereby reducing their momentum. The stream of ions forms a closed charge and mass transfer loop during operation, the loop comprising travel through an interplanetary or interstellar vacuum environment between the ionisation and propulsion module and the tapered target, and a return pathway to the ionisation and propulsion module that is shielded from the external electric field. Only the momentum change during the travel through the interplanetary or interstellar vacuum environment between the ionisation and propulsion module and the tapered target contributes to the net reactive force on the spacecraft, thereby maintaining mass and charge neutrality of the spacecraft during steady-state operation.

The tapered target intercepts the incoming ion stream and directs it into a toroidal magnetic deflection beamline, which reverses the stream's direction by 180°. The ions then pass through a hollow shielded beamline composed of metallised rigid segments joined by flexible metallised connectors that enable angular repositioning in response to varying external magnetic fields. The shielded beamline provides electrostatic isolation and mechanical confinement, and its interior is maintained at a repulsive electrostatic potential to minimise ion collisions with the shell walls. The ions enter an ion neutralisation chamber, which either recombines positive ions with electrons to form neutral atoms or detaches excess electrons from negative ions. In the positive ion configuration, the ion neutralisation chamber includes components such as electron injection grids, magnetic confinement, electrostatic shaping electrodes, thermionic casings for energy recovery, plasma windows, and neutral particle extraction baffles. In the negative ion configuration, photo-detachment is facilitated by high-energy photon emitters and charge separation units. Neutral atoms and electrons are returned to the ionisation and propulsion module via an output conduit, which includes integrated pumps and shielded electron transport paths, thereby ensuring closed-loop charge and mass recycling. A dynamic charge neutralisation system, comprising a plurality of ion thrusters, operates during transition phases to eject excess charges and maintain spacecraft charge neutrality.

To accommodate varying mission profiles, the system enables mode switching between acceleration and deceleration by either repositioning the ionisation and propulsion module and target along the frame or by rotating the entire spacecraft. The system further allows for adaptive control by adjusting the distance between the ionisation and propulsion module and the target or by varying the electrostatic potential applied to the target's interior surface in response to changes in the intensity of external electric fields.

### BRIEF DESCRIPTION OF THE DRAWING

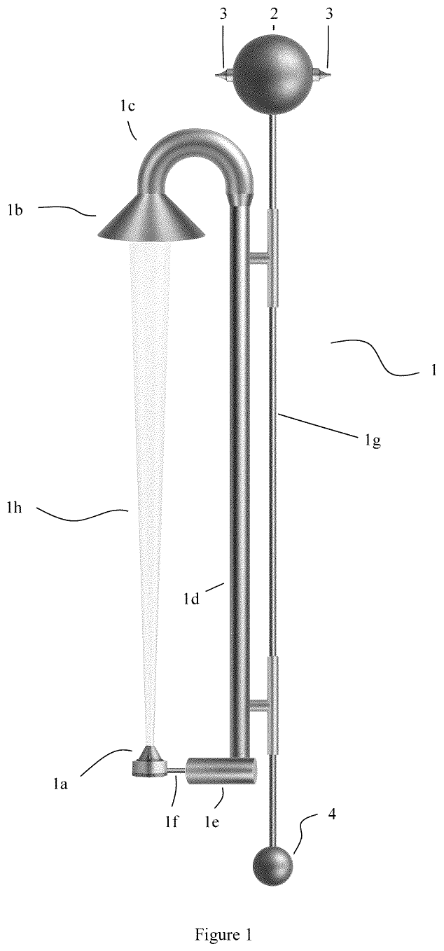

By way of illustration only, an embodiment of the invention is described more fully hereinafter with reference to the accompanying drawing, in which FIG. 1 provides a representation of a near zero-mass change spacecraft propulsion system that utilises low charge-to-mass ratio charged particles, such as positive or negative ions, within a closed-loop mass and charge transfer architecture, wherein the propulsion mechanism incorporates external electric field-assisted deceleration of charged particles to facilitate momentum exchange, thereby enabling sustained thrust without continuous mass expulsion.

### DETAILED DESCRIPTION OF THE INVENTION

In accordance with the present invention, an embodiment of the spacecraft propulsion system, which operates in either acceleration or deceleration mode in a vacuum and is influenced by external electric and magnetic fields, is illustrated with reference to FIG. 1.

In this embodiment, the spacecraft is equipped with at least one motor 1 configured to operate with closed-loop transfer of charge and mass between its internal subsystems, at least one energy source 2, at least one Dynamic Charge Neutralisation (DCN) system 3, and at least one payload 4, in addition to navigation and communication systems, and an array of sensors and control mechanisms.

The motor 1 comprises several internal subsystems, including at least one Ionisation and Propulsion (IP) module 1a; a Charged Particle Path, comprising at least one target 1b, at least one 180° toroidal Magnetic Deflection (MD) beamline 1c, and at least one shielded beamline 1d, which is configured to transport either electrons or positive ions based on the polarity of the internal surfaces potentials. The motor 1 further comprises at least one Ion Neutralisation (IN) chamber 1e and at least one output conduit 1f, all mounted on at least one frame 1g.

The IP module 1a of motor 1 is an ionisation and acceleration unit configured to convert neutral atoms into charged particles, comprising either positive ions and negative ions, and to accelerate the ions in at least one directed stream of ions 1h, with the trajectory of the stream of ions 1h projected to reach the target 1b.

In one embodiment, the target 1b of motor 1 is configured to intercept the ions of the stream 1h and direct them towards the MD beamline 1c. To facilitate the interception and redirection of the stream of ions 1h toward the MD beamline 1c, the target 1b is shaped as a tapered structure that is widely open toward the incoming stream and gradually narrows to match the diameter of the MD beamline 1c. The interior of the target 1b is metallised and serves dual functions: (i) it provides electrostatic isolation of the stream 1h from external electric fields by means of the Faraday cage effect, and (ii) it is maintained at an electrostatic potential of a polarity selected to repel the incoming ions, thereby minimising collisions with the target structure during redirection.

In one embodiment, the IP module 1a and target 1b are specifically designed to mitigate divergence of the stream 1h resulting from mutual Coulomb repulsion between like-ions. At high ion emission rates, the emitted ions are subject to space-charge effects, wherein mutual electrostatic repulsion causes radial expansion of the stream 1h, loss of trajectory coherence, and degradation of propulsion efficiency. To address these effects, the IP module 1a is segmented into an array of individually gated ion emitter units arranged across a distributed surface area. Each individually gated ion emitter unit is configured to release a pulsed output of ions, thereby reducing the instantaneous local ion flux density and minimising inter-ion repulsion within each individual ion stream. Vacuum spacing between individually gated ion emitter units is preserved to reduce mutual deflection between adjacent individual ion streams. The target 1b is correspondingly segmented into an array with receiver surfaces matched to the expected ion beam footprint at the impact plane, ensuring one-to-one mapping of emission paths and avoiding cross-beam interference.

In one embodiment, the positions of the IP module 1a and target 1b on frame 1g are interchangeable, thereby enabling a switch between modes of acceleration and deceleration for the spacecraft, and in response to variations in the direction of the external electric field. For example, during the acceleration phase, the IP module 1a emits ions in a direction opposite to the spacecraft's intended trajectory. For deceleration, the IP module 1a and target 1b swap positions on frame 1g, enabling the IP module 1a to emits ions in alignment with the spacecraft's trajectory.

In an alternative embodiment, instead of physically interchanging the positions of the IP module 1a and target 1b on frame 1g, the spacecraft performs a controlled rotational manoeuvre such that the relative orientation of the IP module 1a and target 1b with respect to the external electric field is reversed. This reorientation enables a transition between acceleration and deceleration modes without requiring mechanical repositioning of internal subsystems of motor 1.

In one embodiment, the distance between the IP module 1a and the target 1b on frame 1g is dynamically adjustable, allowing the propulsion system to adapt to variations in the intensity of the external electric field.

In an alternative embodiment, instead of adjusting the distance between the IP module 1a and the target 1b, the propulsion system adapts to variations in the intensity of the external electric field by dynamically varying the electrostatic potential applied to the interior surface of the target 1b. By adjusting this potential, the propulsion system can regulate the deceleration profile of the incoming positive ions, thereby controlling their velocity upon arrival.

In one embodiment, to counteract the deviation of the stream of ions 1h caused by the external magnetic field, IP module 1a and target 1b are situated on planes oriented at varying angles to the principal axis of frame 1g. These angles can be dynamically modified based on the strength and orientation of the external magnetic field. Mechanisms for repositioning IP module 1a and target 1b along frame 1g are integrated into both IP module 1a and target 1b.

The MD beamline 1c of motor 1 is an arced beamline comprising a hollow metallised cylindrical shell with an integrated toroidal array of magnets selected from permanent magnets or electromagnets, configured to bend and reverse the direction of motion of the stream of ions 1h by 180°, directing the stream of ions 1h into the shielded beamline 1d for subsequent transit to the IN chamber 1e. By way of example, a lightweight magnetic guidance system is employed to achieve the 180° deflection of the stream of ions 1h, utilising a thin layer of permanent magnets surrounding the curved segment of the MD beamline 1c. By way of example, high-coercivity, radiation-resistant permanent magnet materials such as samarium-cobalt (SmCo) or nanostructured ferrite composites are embedded within the shell of the MD beamline 1c. The MD beamline 1c serves dual functions: (i) it provides electrostatic isolation to the stream of ions 1h from external electric fields by means of the Faraday cage effect, and (ii) it offers mechanical confinement to preserve the coherence of the stream of ions 1h′ trajectory.

In one embodiment, the shielded beamline 1d of motor 1 connects the MD beamline 1c to the IN chamber 1e, allowing for the transit of the stream of ions 1h from the MD beamline 1c to the IN chamber 1e. The shielded beamline 1d comprises at least one segment, or a plurality of segments, each segment being a rigid and non-deformable hollow metallised shell connected to neighbouring segments via flexible metallised connectors, the flexible connectors being configured to allow repositioning in response to variations in the external magnetic field of the target 1b with respect to the IP module 1a on planes oriented at varying angles to the principal axis of the frame 1g. The metallised shell of each segment and the metallised connectors are configured to provide electrostatic isolation of the stream of ions 1h from external electric fields via the Faraday cage effect, thereby preserving the constant momentum and velocity of the stream of ions 1h during transit without affecting the thrust generated by the spacecraft. Additionally, the shielded beamline 1d provides mechanical confinement to maintain the coherence of the stream of ions' 1h trajectory, and the interior of the shielded beamline is maintained at an electrostatic potential sufficient to repel the transiting ions and minimise collisions with the inner surface of the shell during transit.

In one embodiment, the IN chamber 1e of motor 1 provides a confined environment in which positive ions, delivered via the shielded beamline 1d, encounter electrons that were separated and routed from the IP module 1a during the ionisation of neutral atoms. In this embodiment, the IN chamber 1e comprises a sealed cavity configured to facilitate the controlled recombination of positive ions and electrons into neutral, for example, hydrogen atoms. The IN chamber 1e includes a proton inlet connected to the shielded beamline 1d and a neutral atom outlet connected to the output conduit 1f. Within the IN chamber 1e, at least one set of electron injection grids is positioned circumferentially near the proton entry point, configured to introduce electrons into the central volume where they spatially and temporally overlap with the incoming positive ions. A magnetic guidance system, comprising a set of low-strength magnetic coils, is arranged along the chamber axis to confine and decelerate the protons via magnetic curvature, thereby increasing their dwell time within the recombination zone. Electrostatic shaping electrodes are integrated into the IN chamber 1e's walls to guide and compress the electron distribution, enhancing the recombination efficiency. The inner surface of the chamber is lined with a thermionic casing formed of heat-resistant, high work function material, such as tungsten or a molybdenum alloy, configured to capture and partially convert the thermal energy released during the recombination process into usable electrical energy. To ensure selective particle transfer, the IN chamber 1e is equipped with at least one plasma window positioned at the interface with the incoming stream of ions 1h, generated and stabilised via electromagnetic coils or radiofrequency electrode arrays. The plasma window comprises a high-density ionised gas, which permits the passage of ions, while impeding the backflow of neutral atoms or molecules through mechanisms such as thermal collisions, scattering, and magnetic confinement. To ensure selective egress, the IN chamber 1e further comprises a neutral atom or molecules extraction baffle positioned at the outlet, shaped and electrostatically shielded to allow only neutral atoms or molecules to transit into the output conduit 1f, while preventing the escape of residual ions. This internal structure maximises recombination probability while preserving the energy and mass recycling principles of the propulsion system.

In an alternative embodiment, the IN chamber 1e is configured to facilitate electron detachment from negative ions. In this configuration, the IN chamber 1e comprises a sealed cavity wherein negative ions, delivered via the shielded beamline 1d, enter a controlled electron detachment zone. The IN chamber 1e is equipped with at least one high-energy photon emitter, such as an ultraviolet or soft X-ray laser, positioned circumferentially near the negative ion entry point. The photon emitter is configured to irradiate the incoming negative ions, thereby inducing photo-detachment of excess electrons. A charge separation unit is integrated downstream of the electron detachment zone to prevent stripped electrons from entering the return mass flow, ensuring that only neutral atoms or molecules are transported through the neutral atom outlet into the output conduit 1f and returned to the ionisation and propulsion module 1a. In this configuration, the plasma window remains positioned between the shielded beamline and the ion neutralisation chamber to prevent neutral atoms from re-entering the shielded beamline, while the charge separation unit prevents residual negative ions from entering the output conduit.

In one embodiment, the output conduit 1f of motor 1 is configured to perform dual functions: (i) to direct neutral hydrogen atoms or hydrogen molecules (H₂), formed in the recombination chamber 1e, back to the IP module 1a for reuse, and (ii) to transport electrons from the IP module 1a to the recombination chamber 1e for recombination with positive ions. To facilitate the movement of neutral particles, the output conduit comprising at least one pump integrated within the neutral particle flow path, configured to induce directed flow of neutral particles through the conduit. The electron transport path comprises at least one shielded, metallised beamline structured to function as a Faraday cage, thereby providing electrostatic isolation from the external electric fields and minimising electromagnetic interference. The output conduit 1f is positioned in close proximity to the IP module 1a in order to minimise its length and associated mass.

In an alternative embodiment, configured for electron detachment from negative ions in the IN chamber 1e, the output conduit 1f functions to transport neutral atoms or molecules and to transport stripped electrons from the IN chamber 1e back to the ionisation and propulsion module 1a, thereby maintaining closed-loop charge transfer within the propulsion system.

The frame 1g of motor 1 is constructed as a non-deformable and non-elastic structural beam, with its principal axis aligned with the trajectory of the spacecraft. The frame serves as the primary support structure for mounting the motor 1, the energy source 2, the DCN system 3, and the payload 4.

In this embodiment, the energy source 2, together with its associated subsystems, provides the necessary power for the operation of the spacecraft.

In this embodiment, the DCN system 3 comprising a plurality of ion thrusters, maintains the spacecraft's charge neutrality by compensating for imbalances caused by the emission of electrically charged particles during the initiation and cessation of motor 1's operation.

In this embodiment, the propulsion system operates by using the interaction between the emitted ions and the external electric field. The ions that make up the stream 1h possess inherent electric charges and rest mass, enabling the transmission of electric charge and momentum between the IP module 1a and the target 1b. Upon being emitted by the IP module 1a into the vacuum, the ions carry an initial momentum. During their journey towards the target 1b, they encounter an external electric field, which performs work on them, resulting in a reduction of their initial momentum. Therefore, by the time the ions reach the target 1b, their momentum is reduced compared to when they were first emitted.

The emission of ions from the IP module 1a toward the target 1b induces a reactive force on the spacecraft in the opposite direction, in accordance with the conservation of momentum. As the ions decelerate en route under the influence of external electric fields, the resulting reduction in their momentum leads to a net momentum transfer to the spacecraft, thereby producing thrust in the direction opposite to the propagation of the stream 1h.

In this embodiment, the motor 1 comprises two distinct paths for the movement of ions: (i) the forward path from the IP module 1a to the target 1b, and (ii) the return Charged Particle Path from the target 1b to the IP module 1a via the MD beamline 1c, the shielded beamline 1d, the IN chamber 1e, and the output conduit 1f. In the forward path, ions emitted by the IP module 1a interact with external electric fields, undergoing deceleration and thereby a reduction in momentum as the electric fields perform work on them. In the return path, the charge and mass neutrality of motor 1 is preserved by transferring the decelerated ions back to the IP module 1a with minimal interaction with external forces, owing to the electrostatic shielding provided throughout the enclosed path. This architecture ensures that only the momentum change during the forward path contributes to the net reactive force on the spacecraft, thereby facilitating propulsion without altering the spacecraft's overall mass or charge state.

In this embodiment, the ions retain a residual velocity upon reaching the target 1b, enabling their return from the target 1b through the MD beamline 1c and the shielded beamline 1d to the IN chamber 1e.

In this embodiment, electrons within motor 1 are permanently shielded from the external electric fields and therefore do not participate in momentum exchange with the spacecraft.

The DCN system 3, when the IP module 1a emits positive ions, is configured to eject negative charges to counterbalance net negative charge accumulation. When the IP module 1a emits negative ions, the DCN system 3 is configured to eject positive charges to counterbalance net positive charge accumulation. The DCN system 3 ejects charges into the vacuum environment only during the initiation phase of motor 1 operation to counterbalance the temporary net charge on the spacecraft. Similarly, upon cessation of motor 1 operation, the DCN system 3 ejects excess charges into the vacuum to neutralise residual charge on the spacecraft. These operations prevent charge accumulation that could otherwise result in Lorentz forces acting on both the ions emitted by the IP module 1a and the spacecraft, producing equal and opposite momentum changes that cancel each other. The DCN system 3 handles only negligibly small quantities of mass relative to the spacecraft and functions exclusively during transient charge imbalances at operational transitions. Sensors and feedback mechanisms regulate the emission of positive and negative charges, ensuring dynamic charge neutralisation and nullifying residual charge accumulation, thereby mitigating external electromagnetic forces acting on the spacecraft. In this embodiment, the emission of either positive or negative charges by the ion thrusters of the DCN system 3 occurs at positions selected to counterbalance the momentum of the emitted charges, ensuring no unintended interference with the spacecraft's intended trajectory.

In summary, the spacecraft's ability to accelerate and decelerate is based on the principles of momentum conservation and the modulation of the momentum of emitted ions through interaction with external electric fields. In operation, ions are emitted from the IP module 1a with a defined initial momentum. As these ions travel toward the target 1b, they encounter an external electric field that performs work on them, resulting in a reduction of their momentum prior to arrival at the target 1b. This change in momentum produces a reactive force on the spacecraft in the opposite direction of the ions propagation, thereby generating thrust. The return path of the ions, which are enclosed within the target 1b, the MD beamline 1c, the shielded beamline 1d, the IN chamber 1e, the output conduit 1f, and back to the IP module 1a, occurs within an electrostatically shielded environment, preventing further interaction with external electric fields and ensuring the system remains mass-and charge-neutral. To achieve deceleration, the IP module 1a and target 1b are repositioned diametrically relative to the spacecraft's trajectory, such that the ions are emitted in the direction of travel. This reverse emission produces a counteracting force that slows the spacecraft. The system thus enables controlled acceleration and deceleration without expelling net mass and while maintaining electric charge neutrality.

### NON-PATENT LITERATURE REFERENCES

Andrews, D.G. and Zubrin, R.M., 1990. Magnetic sail: Propulsion system for interplanetary travel. Journal of Spacecraft and Rockets, 27(5), pp. 508-513.
Everett, A. and Roman, T., 2011. Time Travel and Warp Drives: A Scientific Guide to Shortcuts through Time and Space. Chicago: University of Chicago Press.
Goebel, D.M. and Katz, I., 2008. Fundamentals of Electric Propulsion: Ion and Hall Thrusters. John Wiley & Sons, Inc. Print ISBN: 9780470429273; Online ISBN: 9780470436448.
Janhunen, P., 2014. Electric solar wind sail: Towards test missions. Review of Scientific Instruments, 85(11), p. 111301.
Michaelis, M.M. and Forbes, A., 2006. Laser propulsion: a review. South African Journal of Science, 102, pp. 289-295.
Vulpetti, G., 1994. A critical review on the viability of a space propulsion based on the solar wind momentum flux. Acta Astronautica, 32(9), pp. 641-644.
U.S. patent application Ser. No. 19/001,439, titled “Near Zero-Mass Change Propulsion System for Interplanetary and Interstellar Spacecraft”.

1. A spacecraft comprising a payload and a propulsion system, the propulsion system comprising:
at least one motor configured to operate in an interplanetary or interstellar vacuum environment in the presence of external electric and magnetic fields originating from one or more sources selected from solar, interstellar, intergalactic, artificial, or combinations thereof, the motor comprising:
at least one ionisation and propulsion module configured to ionise neutral atoms into ions having either positive or negative charge, and to emit the ions in at least one directed stream of ions into the interplanetary or interstellar vacuum environment in the presence of external electric and magnetic fields;
at least one charged particle path having a metallised and electrostatically charged interior surface, configured to maintain electrostatic isolation of the ions from external electric fields, and further configured with a charge of electrostatic polarity sufficient to repel the stream of ions away from the interior surface and minimise collisions, the charged particle path comprising, in sequence: at least one tapered target configured to intercept the stream of emitted ions and direct the ions towards at least one toroidal magnetic deflection beamline configured to reverse the direction of the stream of ions by 180 degrees, and to direct the stream of ions towards at least one hollow shielded beamline configured to transport the stream of ions while maintaining electrostatic isolation from external electric fields;
at least one ion neutralisation chamber configured to receive the ions from the shielded beamline and to facilitate recombination of the ions with electrons to form neutral atoms, if the ions are positively charged, or to facilitate electron detachment if the ions are negatively charged;
at least one output conduit configured to return the neutral atoms from the ion neutralisation chamber to the ionisation and propulsion module, and to transport electrons between the ionisation and propulsion module and the ion neutralisation chamber for recombination if the ions are positively charged, or for electron detachment if the ions are negatively charged;
at least one frame constructed as a non-deformable and non-elastic structural beam, with its principal axis aligned with the trajectory of the spacecraft, serving as the primary support structure for mounting the motor and the payload;
at least one energy source mounted on the frame, configured to power the spacecraft;
at least one dynamic charge neutralisation system mounted on the frame, configured to eject charged particles into space during operational transitions to maintain electrical neutrality of the spacecraft;
wherein the ions are emitted from the ionisation and propulsion module with an initial momentum, and the emission of the ions induces a reactive force on the spacecraft in a direction opposite to the propagation of the ions, and, as the ions travel toward the tapered target, they interact with an external electric field that performs work on the ions, thereby reducing their momentum; and wherein the stream of ions forms a closed charge and mass transfer loop during operation, the loop comprising travel through an interplanetary or interstellar vacuum environment between the ionisation and propulsion module and the tapered target, and a return pathway to the ionisation and propulsion module that is shielded from the external electric field, wherein only the momentum change during the travel through an interplanetary or interstellar vacuum environment between the ionisation and propulsion module and the tapered target contributes to the net reactive force on the spacecraft, thereby maintaining mass and charge neutrality of the spacecraft during steady-state operation.

2. The propulsion system of claim 1, wherein the ionisation and propulsion module emits ions into an interplanetary or interstellar vacuum environment, thereby creating an excess of electrons if the emitted ions are positively charged, or deficit of electrons if the emitted ions are negatively charged, within the ionisation and propulsion module, and wherein the excess or deficit of electrons is compensated in the ion neutralisation chamber by a recombination process if the ions are positively charged, or by electron detachment if the ions are negatively charged.

3. The propulsion system of claim 2, wherein the electrons retained within the motor are electrostatically isolated from external electric fields, thereby being excluded from contributing to thrust generation for the spacecraft.

4. The propulsion system of claim 1, wherein the ions emitted from the ionisation and propulsion module retain a residual velocity upon reaching the tapered target, enabling their return from the tapered target through the toroidal magnetic deflection beamline and the hollow shielded beamline to the ion neutralisation chamber.

5. The propulsion system of claim 1, wherein the ionisation and propulsion module comprises either a single ion emitter unit or a segmented array of ion emitter units, each configured to emit a pulsed stream of ions, wherein each ion emitter unit in the array emits a distinct stream of ions and is spatially separated from adjacent ion emitter units to minimise Coulomb repulsion between the emitted like-charged ions, and wherein temporal separation between pulses further reduces Coulomb repulsion.

6. The propulsion system of claim 1, wherein the target is tapered such that it is widely open toward the incoming stream of ions and gradually narrows to match the diameter of the toroidal magnetic deflection beamline, and comprises either a single tapered target unit or a segmented array of tapered target units, each tapered target unit in the array configured to intercept a distinct stream of ions emitted from a corresponding ion emitter unit in the segmented array of ion emitter units.

7. The propulsion system of claim 1, wherein, to counteract deviation of the stream of ions caused by an external magnetic field, the ionisation and propulsion module and the tapered target are situated on planes oriented at varying angles to the principal axis of the frame, and wherein the angles are dynamically adjustable based on the strength and orientation of the external magnetic field.

8. The propulsion system of claim 1, wherein the toroidal magnetic deflection beamline comprises a curved hollow shell, a first end of the hollow shell being connected to the narrow end of the tapered target and a second end being connected to the hollow shielded beamline, the shell comprising an integrated array of magnets selected from permanent magnets or electromagnets, the array of magnets being configured to generate a magnetic field that guides and curves the path of the stream of ions.

9. The propulsion system of claim 1, wherein the hollow shielded beamline comprises at least one segment, or a plurality of segments, each segment being a rigid and non-deformable hollow metallised shell connected to neighbouring segments via flexible metallised connectors, the flexible connectors being configured to allow repositioning in response to variations in the external magnetic field of the target with respect to the ionisation and propulsion module on planes oriented at varying angles to the principal axis of the frame, wherein the metallised shell of each segment and the metallised connectors are configured to provide electrostatic isolation of the stream of ions from external electric fields, thereby preserving the constant momentum and velocity of the stream of ions during transit without affecting the thrust generated by the spacecraft, and wherein the shielded beamline provides mechanical confinement to maintain the coherence of the stream of ions' trajectory, and the interior of the shielded beamline is maintained at an electrostatic potential sufficient to repel the transiting ions and minimise collisions with the inner surface of the shell during transit.

10. The propulsion system of claim 1, wherein the ion neutralisation chamber is configured as a sealed cavity, the internal configuration of the ion neutralisation chamber being constructed either in a positive ion configuration for use with positive ions, or in a negative ion configuration for use with negative ions, wherein, in the positive ion configuration, the IN chamber comprises at least one proton inlet connected to the hollow shielded beamline, at least one electron injection grid positioned circumferentially near the proton entry point, a magnetic guidance system comprising low-strength magnetic coils to confine and decelerate the protons, electrostatic shaping electrodes integrated into the chamber walls to compress the electron distribution, a thermionic casing configured to capture and partially convert the thermal energy released during the recombination process into usable electrical energy, a plasma window positioned at the interface with the incoming stream of ions to control charged particle passage and prevent backflow of neutral atoms or molecules, and a neutral atom or molecules extraction baffle shaped and electrostatically shielded to selectively direct neutral atoms or molecules into the output conduit; and wherein, in the negative ion configuration, the ion neutralisation chamber comprises at least one high-energy photon emitter positioned circumferentially near the negative ion entry point, configured to irradiate the incoming negative ions to induce photo-detachment of excess electrons, and a charge separation unit positioned downstream of the electron detachment zone to prevent stripped electrons from entering the return mass flow, wherein a plasma window remains positioned between the shielded beamline and the ion neutralisation chamber to prevent neutral atoms or molecules from re-entering the shielded beamline, and wherein the charge separation unit prevents residual negative ions from entering the output conduit, ensuring that only neutral atoms or molecules are transported through the output conduit to the ionisation and propulsion module.

11. The propulsion system of claim 1, wherein the output conduit is configured as a hollow passage connecting the ion neutralisation chamber to the ionisation and propulsion module, wherein the output conduit is configured in a positive ion configuration to perform dual functions of directing neutral atoms or molecules formed in the ion neutralisation chamber back to the ionisation and propulsion module and transporting electrons from the ionisation and propulsion module to the ion neutralisation chamber for recombination with positive ions, and is configured in a negative ion configuration to transport neutral atoms or molecules and stripped electrons from the ion neutralisation chamber back to the ionisation and propulsion module for reuse, the output conduit comprising at least one pump integrated within the neutral particle flow path, configured to induce directed flow of neutral particles through the conduit, and wherein the electron transport path comprises at least one shielded metallised beamline configured to provide electrostatic isolation from external electric fields and to minimise electromagnetic interference, thereby maintaining closed-loop charge transfer within the propulsion system.

12. The propulsion system of claim 1, wherein the dynamic charge neutralisation system comprises a plurality of ion thrusters configured to emit charges into the interplanetary or interstellar vacuum environment during operational transitions, wherein when the ionisation and propulsion module emits positive ions, the dynamic charge neutralisation system is configured to emit negative charges to counterbalance net negative charge accumulation, and wherein when the ionisation and propulsion module emits negative ions, the dynamic charge neutralisation system is configured to emit positive charges to counterbalance net positive charge accumulation, the dynamic charge neutralisation system thereby preventing charge accumulation that would otherwise result in Lorentz forces acting on both the ions emitted by the ionisation and propulsion module and the spacecraft, causing equal and opposite momentum changes that cancel each other.

13. The propulsion system of claim 12, wherein the emission of either positive or negative charges by the ion thrusters of the dynamic charge neutralisation system occurs at positions selected to counterbalance the momentum of the emitted charges, ensuring no unintended interference with the spacecraft's intended trajectory.

14. The propulsion system of claim 1, wherein the spacecraft is configured to switch between acceleration and deceleration modes and in response to variations in the direction of the external electric field by either repositioning and reorienting the ionisation and propulsion module and the tapered target along the motor's frame to positions opposite their initial alignment, or by performing a controlled rotational manoeuvre to reverse the orientation of the spacecraft relative to its intended trajectory.

15. The propulsion system of claim 1, wherein the spacecraft is configured to adapt to variations in the intensity of the external electric field by either dynamically adjusting the distance between the ionisation and propulsion module and the tapered target along the structural frame, or by dynamically varying the electrostatic potential applied to the interior surface of the tapered target to regulate the deceleration profile of the incoming ions and control their velocity upon arrival.
